(19) United States
(12) Patent Application Publication
(10) Pub. No.: US 2023/0290999 A1
(43) Pub. Date: Sep. 14, 2023

(54) SOLID ELECTROLYTE FREE-STANDING MEMBRANE FOR ALL-SOLID-STATE BATTERY AND MANUFACTURING METHOD THEREOF

(71) Applicants: HYUNDAI MOTOR COMPANY, Seoul (KR); KIA CORPORATION, Seoul (KR)

(72) Inventors: Byung Yong Lee, Anyang-si (KR); Dae Yang Oh, Hwaseong-si (KR)

(73) Assignees: HYUNDAI MOTOR COMPANY, Seoul (KR); KIA CORPORATION, Seoul (KR)

(21) Appl. No.: 18/079,445

(22) Filed: Dec. 12, 2022

(30) Foreign Application Priority Data
Mar. 8, 2022 (KR) 10-2022-0029064

(51) Int. Cl. H01M 10/056; H01M 10/0525

(52) U.S. Cl. CPC H01M 10/056; H01M 10/0525; H01M 2300/0091

(57) ABSTRACT

A solid electrolyte free-standing membrane for an all-solid-state battery may include: an amount of about 85% to 98.5% by weight of a sulfide-based solid electrolyte; and an amount of about 1.5% to 15% by weight of a fibrillated polymer.

### CROSS REFERENCE TO RELATED APPLICATION

The present application claims priority to Korean Patent Application No. 10-2022-0029064, filed Mar. 8, 2022, the entire contents of which is incorporated herein for all purposes by this reference.

### BACKGROUND OF THE PRESENT DISCLOSURE

### Field of the Present Disclosure

The present disclosure relates to a solid electrolyte free-standing membrane for an all-solid-state battery and a manufacturing method thereof.

### Description of Related Art

Lithium secondary batteries have been developed as small power sources for smartphones and small electronic devices, and their demand is increasing with the development of electric vehicles.

A lithium secondary battery is composed of cathode material and anode material that can exchange lithium ions and an electrolyte that conducts lithium ions. A typical lithium secondary battery uses a liquid electrolyte in which a lithium salt is dissolved in an organic solvent and includes a separator made of organic fibers that prevent physical contact between a cathode and an anode to prevent a short circuit. Since a flammable organic solvent is used as an electrolyte solvent, there is a high risk of fire and explosion when a short circuit occurs due to physical damage, and many accidents actually occur.

An all-solid-state battery replaces a flammable liquid electrolyte with an inorganic solid electrolyte. As an inorganic solid electrolyte, oxide-based solid electrolyte and sulfide-based solid electrolytes are mainly used. Among them, a sulfide-based solid electrolyte is promising because of its high lithium ion conductivity close to that of a liquid electrolyte.

However, the sulfide-based solid electrolyte has a disadvantage in that it's processability and battery stability are poor due to low mechanical properties. Currently, on a small scale, a powder-type solid electrolyte is made into a pellet by applying pressure. However, a sheet-type solid electrolyte membrane is required for mass production, and the mechanical properties of the sheet must be ensured to some extent to withstand the process.

However, it is difficult to ensure fairness because sulfide-based solid electrolytes are fragile when pressure is applied. There is a method of coating the sulfide-based solid electrolyte together with the separator used in the conventional lithium ion battery to overcome this problem, but the resistance of the separator is added, which offsets the advantage of the excellent lithium ion conductivity of the sulfide-based solid electrolyte. In addition, since the thickness of the separator cannot be reduced, it is difficult to lower the thickness of the entire film, and since a solvent is used for coating, the performance of the solid electrolyte may be affected. On the other hand, a free-standing membrane including a sulfide-based solid electrolyte can be made by using a binder dissolved in a solvent. However, since the sulfide-based solid electrolyte has poor chemical stability, the lithium ion conductivity of the sulfide-based solid electrolyte may be decelerated by the solvent.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a free-standing membrane including a sulfide-based solid electrolyte having high lithium ion conductivity and being mechanically and chemically stable.

The objective of the present disclosure is not limited to the object mentioned above. The objective of the present disclosure will become more apparent from the following description and will be realized by means and combinations thereof described in the claims.

In an aspect, a solid electrolyte free-standing membrane for an all-solid-state battery may include: an amount of about 85% to 98.5% by weight of a sulfide-based solid electrolyte; and an amount of about 1.5% to 15% by weight of a fibrillated polymer.

The fibrillated polymer may have a diameter of about 0.01 μm to 10 μm.

The fibrillated polymer may include polytetrafluoroethylene (PTFE).

The solid electrolyte free-standing membrane may be divided into area 1, area 2 and area 3 along the thickness direction from one surface with respect to its cross section.

The thickness ratio of the area 1, area 2 and area 3 may be 1:2.5:3.5.

When the content of elemental sulfur in area 1 is represented as 100, the content of elemental sulfur in each of area 2 and area 3 are in a range of about 80 to 120.

The solid electrolyte free-standing membrane for an all-solid-state battery may have a thickness of about 100 μm to 200 μm.

The solid electrolyte free-standing membrane for an all-solid-state battery may have a lithium ion conductivity of about 0.15 mS/cm or more.

The solid electrolyte free-standing membrane for an all-solid-state battery may have a tensile strength of about 0.5 MPa or more and a breaking elongation of about 29.6% or more.

In an aspect, a method of manufacturing a solid electrolyte free-standing membrane for an all-solid-state battery may include: preparing a mixture including a sulfide-based solid electrolyte and a polymer powder capable of fibrillating; applying shear stress to the mixture so that the mixture becomes clay; and forming the clay into a film to obtain a solid electrolyte free-standing membrane, in which the solid electrolyte free-standing membrane may include an amount of about 85% to 98.5% by weight of a sulfide-based solid electrolyte and an amount of about 1.5% to 15% by weight of a fibrillated polymer.

The polymer powder capable of fibrillating may have an average diameter (D50) of about 1 μm to 1,000 μm.

The mixture may not include a solvent.

By applying shear stress to the mixture, the binder powder capable of fibrillating may be fibrillated.

According to an exemplary embodiment of the present disclosure, it is possible to obtain a solid electrolyte free-standing membrane for an all-solid-state battery having excellent lithium ion conductivity.

According to an exemplary embodiment of the present disclosure, it is possible to obtain a solid electrolyte free-standing membrane for an all-solid-state battery having excellent chemical and mechanical stability.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 shows an all-solid-state battery according to an exemplary embodiment of the present disclosure;

FIG. 2 shows a solid electrolyte free-standing membrane according to Example 3;

FIG. 3 shows a cross section of the solid electrolyte free-standing membrane according to Example 3 analyzed by a scanning electron microscope (SEM);

FIG. 4A and FIG. 4B show a cross-section of a solid electrolyte free-standing membrane according to Example 3 analyzed by an electron microscope and a scanning electron microscope-energy dispersive spectrometer (SEM-EDS);

FIG. 5A and FIG. 5B show a solid electrolyte free-standing membrane according to a Comparative Example analyzed by an electron microscope and scanning electron microscope-energy dispersive spectrometer (SEM-EDS);

FIG. 6 shows the lithium ion conductivity of the solid electrolyte free-standing membrane according to Examples 1 to 5; and

FIG. 7 shows the tensile strength of the solid electrolyte free-standing membranes according to Examples 2, 3, and 5.

FIG. 8 shows the breaking elongation of the solid electrolyte free-standing membranes according to Examples 2, 3, and 5.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

The above objectives, other objectives, features, and advantages of the present disclosure will be easily understood through the following exemplary embodiments However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc. may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In the present specification, the term “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where there is another part in between. Conversely, when a part of a layer, film, region, plate, etc. is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value, containing the maximum value are included unless otherwise indicated.

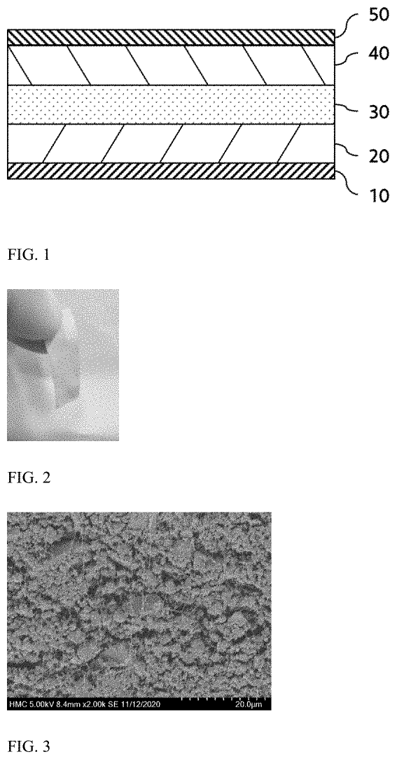

FIG. 1 shows an all-solid-state battery according to an exemplary embodiment of the present disclosure. The all-solid-state battery may be one in which an anode current collector 10, an anode active material layer 20, a solid electrolyte free-standing membrane 30, a cathode active material layer 40, and a cathode current collector 50 are stacked.

The anode current collector 10 may be an electrically conductive plate-shaped substrate. Specifically, the anode current collector 10 may be in the form of a sheet, a thin film, or a foil.

The anode current collector 10 may include a material that does not react with lithium. Specifically, the anode current collector 10 may include at least one selected from the group consisting of Ni, Cu, stainless steel (SUS), and a combination thereof.

The anode active material layer 20 may include an anode active material, a solid electrolyte, a binder, and the like.

The anode active material is not particularly limited but may include, for example, a carbon active material or a metal active material.

The carbon active material may include graphite, such as meso-carbon microbeads (MCMB) and highly oriented graphite (HOPG), and amorphous carbon, such as hard carbon and soft carbon.

The metal active material may include In, Al, Si, Sn, or an alloy containing at least one of these elements.

The solid electrolyte may include an oxide-based solid electrolyte or a sulfide-based solid electrolyte. It may be preferable to use a sulfide-based solid electrolyte having high lithium ion conductivity.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S-SiΩ, Li₂S—Si₂—LiI, Li₂S—Si₂—LiBr, Li₂S—Si₂—LiCl, Li₂S—Si₂—B₂S₃—LiI, Li₂S—Si₂—P₂S₅—LiI, Li₂S—B₂S₃, Li₂S—P₂S₅—ZₘSₙ (where m and n are positive numbers, and Z is one of Ge, Zn, and Ga), Li₂S—GeS₂, Li₂S—Si₂—Li₃PO₄, Li₂S—Si₂-LiₓMO_{y} (where m and n are positive numbers, and Z is one of Ge, Zn, and Ga, x and y are positive numbers, M is one of P, Si, Ge, B, Al, Ga, In), Li₁₀GeP₂S₁₂, and the like.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The cathode active material layer 40 may include a cathode active material, a solid electrolyte, a conductive material, a binder, and the like.

The cathode active material is not particularly limited but may include, for example, an oxide active material or a sulfide active material.

The oxide active material may include a rock salt layer type active material such as LiCoO₂, LiMnO₂, LiNiO₂, LiVO₂, Li₁₊ₓNi_{1/3}Co_{1/3}Mn_{1/3}O₂, etc., a spinel type active material such as LiMn₂O₄, Li(Ni_{0.5}Mn_{1.5})O₄, a reverse spinel type active material such as LiNiVO₄ and LiCoVO₄, an olivine type active material such as LiFePO₄, LiMnPO₄, LiCoPO₄, LiNiPO₄, silicon-containing active material such as Li₂FeSiO₄, Li₂MnSiO₄, a rock salt layer type active material in which a part of the transition metal is substituted with a dissimilar metal such as LiNi_{0.8}Co_{(0.2-x)}AlₓO₂(0<x<0.2), a spinel type active material in which a part of the transition metal is substituted with a dissimilar metal such as Li₁₊ₓMn_{2-x-y}M_{y}O₄ (M is at least one of Al, Mg, Co, Fe, Ni, Zn, and O<x+y<2), and a lithium titanate such as Li₄Ti₅O₁₂, or the like.

The sulfide active material may include copper Chevrel, iron sulfide, cobalt sulfide, nickel sulfide, or the like.

The solid electrolyte may include an oxide-based solid electrolyte or a sulfide-based solid electrolyte. It may be preferable to use a sulfide-based solid electrolyte having high lithium ion conductivity.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is one of Ge, Zn, and Ga, m and n are positive numbers, and Z is one of Ge, Zn, and Ga), Li₂S—GeS₂, Li₂S—SiS₂—Li₃PO₄, Li₂S—SiS₂-LiₓMO_{y} (where m and n are positive numbers, and Z is one of Ge, Zn, and Ga, x and y are positive numbers, M is one of P, Si, Ge, B, Al, Ga, In), Li₁₀GeP₂S₁₂, and the like.

The conductive material may provide an electron conduction path in the electrode. The conductive material may include sp² carbon material such as carbon black, conductive graphite, ethylene black, carbon nanotube, or graphene.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The cathode current collector 50 may be an electrically conductive plate-shaped substrate. Specifically, the cathode current collector 50 may be in the form of a sheet or a thin film.

The cathode current collector 50 may include at least one selected from the group consisting of indium, copper, magnesium, aluminum, stainless steel, iron, and a combination thereof.

The solid electrolyte free-standing membrane 30 may be interposed between the anode active material layer 20 and the cathode active material layer 40 and may conduct lithium ions.

The present disclosure is characterized by providing a solid electrolyte layer in the form of a free-standing membrane having excellent lithium ion conductivity and mechanical and chemical stability.

The conventional solid electrolyte layer in the form of a free-standing membrane is prepared by placing a separator or nonwoven fabric in the center, coating and drying a slurry containing a solid electrolyte on one or both sides thereof. However, when the viscosity of the slurry is low, the solid electrolyte may penetrate between the pores of the nonwoven fabric, and thus processability is very poor. In addition, in the process of drying the slurry, pores are formed due to the removal of the solvent, and the mechanical and electrochemical properties of the solid electrolyte layer are deteriorated. The nonwoven fabric not only acts as a kind of resistance but also the solid electrolyte cannot be evenly distributed in the solid electrolyte layer by the nonwoven fabric so the lithium ion conductivity is remarkably reduced.

The present disclosure solves the above problems by implementing a solid electrolyte free-standing membrane 30 including a sulfide-based solid electrolyte and a fibrillated polymer. Since the fibrillated polymer is entangled with the sulfide-based solid electrolyte and mechanical properties are improved, the solid electrolyte free-standing membrane 30 may maintain its shape. At this time, since the contact between the fibrillated polymer and the sulfide-based solid electrolyte is minimized, the decrease in lithium ion conductivity is significantly reduced compared to when a binder dissolved in a solvent is used.

The solid electrolyte free-standing membrane 30 may include an amount of about 85% to 98.5% by weight of the sulfide-based solid electrolyte and an amount of about 1.5% to 15% by weight of the fibrillated polymer. When the content of the fibrillated polymer is less than 1.5% by weight, it is difficult to increase the mechanical properties of the solid electrolyte free-standing membrane 30 to a satisfactory level, and when the content of the fibrillated polymer exceeds 15% by weight, the degree of improvement in mechanical properties compared to the amount added may be insignificant.

The sulfide-based solid electrolyte is not particularly limited but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—Si₂, Li₂S—Si₂—LiI, Li₂S—Si₂—LiBr, Li₂S—Si₂—LiCl, Li₂S—Si₂—B₂S₃—LiI, Li₂S—Si₂—P₂S₅—LiI, Li₂S—B₂S₃, Li₂S—P₂S₅—ZₘSₙ (where m and n are positive numbers, and Z is one of Ge, Zn, and Ga, m and n are positive numbers, and Z is one of Ge, Zn, and Ga), Li₂S—GeS₂, Li₂S—SiS₂—Li₃PO₄, Li₂S—SiS₂-LiₓMO_{y} (where m and n are positive numbers, and Z is one of Ge, Zn, and Ga, x and y are positive numbers, M is one of P, Si, Ge, B, Al, Ga, In), Li₁₀GeP₂S₁₂, and the like.

The fibrillated polymer may include polytetrafluoroethylene (PTFE).

Polytetrafluoroethylene (PTFE) is a polymer in which all hydrogen elements of polyethylene (PE) are substituted with fluorine elements. Polytetrafluoroethylene (PTFE) is a polymer with an aliphatic main chain but has excellent thermal stability and electrical stability, and thus is widely applied to the electronic material field. In particular, the polymer has a low highest occupied molecular orbital (HOMO) level and high oxidation stability, so it is mainly used for the cathode. Since the polytetrafluoroethylene (PTFE) has a cylindrical structure, it can be fibrillated even at low temperatures, even though it has a high glass transition temperature (Tg).

The fibrillated polymer may have a diameter of about 0.01 μm to 10 μm. The diameter means the diameter of the cross-section of the fibrillated polymer. The cross-section means a cross-section in which the fibrillated polymer is cut in a direction perpendicular to its longitudinal direction. When the diameter of the fibrillated polymer is less than 0.01 μm, the mechanical properties of the solid electrolyte free-standing membrane 30 may not be sufficient, and when the diameter of the fibrillated polymer exceeds 10 μm, lithium ion conductivity may be deteriorated.

The fibrillated polymer is uniformly distributed in the solid electrolyte free-standing membrane 30 with minimal contact with the sulfide-based solid electrolyte. This means that the sulfide-based solid electrolyte is also uniformly spread in the solid electrolyte free-standing membrane 30. Therefore, in the solid electrolyte free-standing membrane 30, according to an exemplary embodiment of the present disclosure, the decrease in lithium ion conductivity is significantly smaller than the amount of the fibrillated polymer added. This will be described later.

The solid electrolyte free-standing membrane may have a thickness of about 100 μm to 200 μm.

The method of manufacturing the solid electrolyte free-standing membrane 30 may include: preparing a mixture including a sulfide-based solid electrolyte and a polymer powder capable of fibrillating; applying shear stress to the mixture so that the mixture becomes clay; and forming the clay into a film to obtain a solid electrolyte free-standing membrane.

The polymer powder capable of fibrillating may include polytetrafluoroethylene (PTFE).

The polymer powder capable of fibrillating may have an average diameter (D50) of about 1 μm to 1,000 μm.

The mixture, including the sulfide-based solid electrolyte and the polymer powder capable of fibrillating, may be made into clay by applying shear stress. In this process, the polymer powder may be converted into a fibrillated polymer.

A method of applying the shear stress is not particularly limited. Shear stress may be applied by an apparatus or method commonly used in the technical field to which the present disclosure pertains.

Thereafter, a solid electrolyte free-standing membrane can be obtained by forming the clay into a film.

The method in particular of the said film-forming is not restricted. A film can be formed by an apparatus or method commonly used in the technical field to which the present disclosure pertains.

The method for manufacturing a solid electrolyte free-standing membrane is characterized in that no solvent is used. Therefore, since the sulfide-based solid electrolyte is not chemically modified by the solvent during the manufacturing process, it is possible to prevent the lithium ion conductivity from being lowered.

On the other hand, in the process of removing the solvent, problems such as degradation of adhesive force due to the lifting phenomenon of the binder may occur if the free-standing membrane is formed using a slurry containing a solvent. Since the present disclosure does not use a solvent, the above problems do not occur.

Hereinafter, another form of the present disclosure will be described in more detail through the following examples. The following examples are merely illustrative to help the understanding of the present disclosure, and the scope of the present disclosure is not limited thereto.

### EXAMPLES 1 TO 5

A mixture was prepared by mixing a sulfide-based solid electrolyte and polytetrafluoroethylene powder. At this time, the content of the polytetrafluoroethylene powder was adjusted to about 1.5% by weight (Example 1), about 3% by weight (Example 2), about 5% by weight (Example 3), about 10% by weight (Example 4), and about 15% by weight (Example 5). The mixture was further stirred so that the sulfide-based solid electrolyte and the polytetrafluoroethylene powder were uniformly mixed.

Shear stress was applied to the mixture. It was confirmed that the polytetrafluoroethylene powder was fibrillated, and the mixture became clay.

The clay was calendered to obtain a sheet-shaped solid electrolyte free-standing membrane. The thickness of each solid electrolyte free-standing membrane was about 140 μm.

### COMPARATIVE EXAMPLE

A slurry was prepared by mixing a sulfide-based solid electrolyte and a binder solution. The slurry was applied to both sides of a nonwoven fabric and dried to prepare a solid electrolyte free-standing membrane. The thickness was about 110 μm.

FIG. 2 shows a solid electrolyte free-standing membrane according to Example 3. It can be seen that the solid electrolyte free-standing membrane maintains its shape without any substrate such as a release paper.

FIG. 3 shows a cross-section of the solid electrolyte free-standing membrane according to Example 3 analyzed by a scanning electron microscope (SEM). It can be seen that the fibrillated polymer is spread throughout the free-standing membrane. It can be seen that the surface of the sulfide-based solid electrolyte is not covered by the binder, but the fibrillated polymer is in line contact with the sulfide-based solid electrolyte.

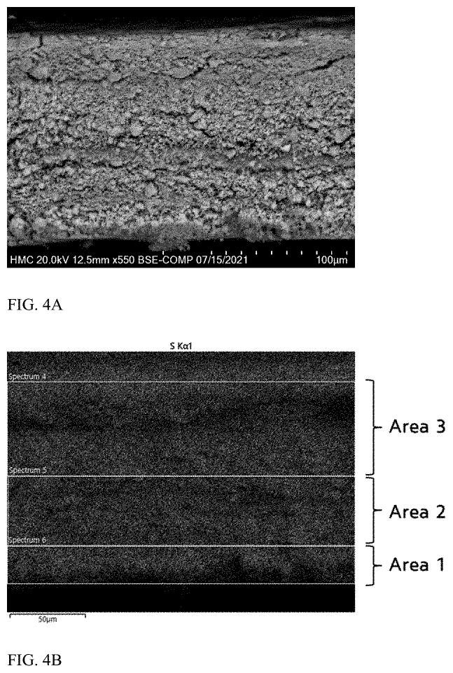

FIG. 4A and FIG. 4B show a cross-section of a solid electrolyte free-standing membrane according to Example 3 analyzed by an electron microscope and a scanning electron microscope-energy dispersive spectrometer (SEM-EDS).

FIG. 5A and FIG. 5B show a solid electrolyte free-standing membrane according to a Comparative Example analyzed by an electron microscope and scanning electron microscope-energy dispersive spectrometer (SEM-EDS).

Referring to FIGS. 4B and 5B, it can be seen the distribution degree of sulfur (S) for each area of each solid electrolyte free-standing membrane. The distribution degree of sulfur (S) is an indicator of the dispersibility of the sulfide-based solid electrolyte.

Referring to FIG. 4B, the solid electrolyte free-standing membrane, according to an exemplary embodiment of the present disclosure, may be divided into area 1, area 2 and area 3 that are arranged in order in a thickness direction from one surface and which are in a thickness ratio of 1:2.5:3.5. In this case, the ratio of sulfur element in area 1, area 2, and area 3 is 27.2:30.5:25.8. Accordingly, when the content of elemental sulfur in area 1 of the solid electrolyte free-standing membrane according to Example 3 is 100, the content of elemental sulfur in area 2 and area 3 is 118 and 105, respectively.

Meanwhile, referring to FIG. 5, when the solid electrolyte free-standing membrane, according to the Comparative Example, is divided into area 1, area 2, and area 3 in the same manner as above, the ratio of the sulfur element in each area is 39.8:12.9:32.3. Similarly to the above, when the content of elemental sulfur in area 1 of the solid electrolyte free-standing membrane according to Comparative Example is 100, the content of elemental sulfur in area 2 and area 3 is 40 and 123. Since area 2 of the Comparative Example is where the nonwoven fabric is positioned, it can be seen that the ratio of elemental sulfur is very small.

As a result, the sulfide-based solid electrolyte is very evenly dispersed in the solid electrolyte free-standing membrane, according to an exemplary embodiment of the present disclosure, as compared to the free-standing membrane including a nonwoven fabric and a separation membrane as in Comparative Examples. Specifically, the solid electrolyte free-standing membrane, according to an exemplary embodiment of the present disclosure, divides into area 1, area 2 and area 3 that are arranged in order in a thickness direction from one surface and which are in a ratio of 1:2.5:3.5, and when the content of elemental sulfur in area 1 is represented as 100, the content of elemental sulfur in each of area 2 and area 3 are in a range of 80 to 120.

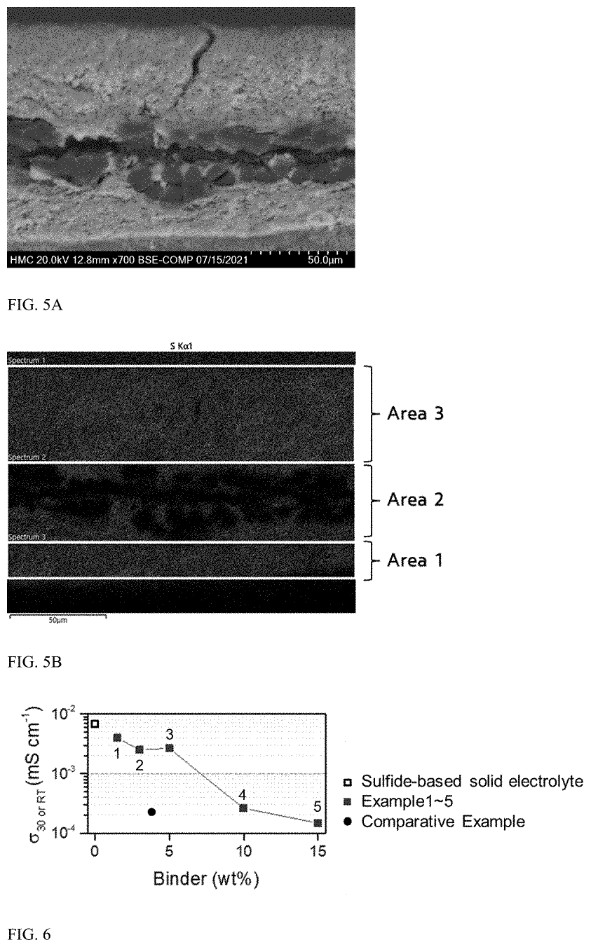

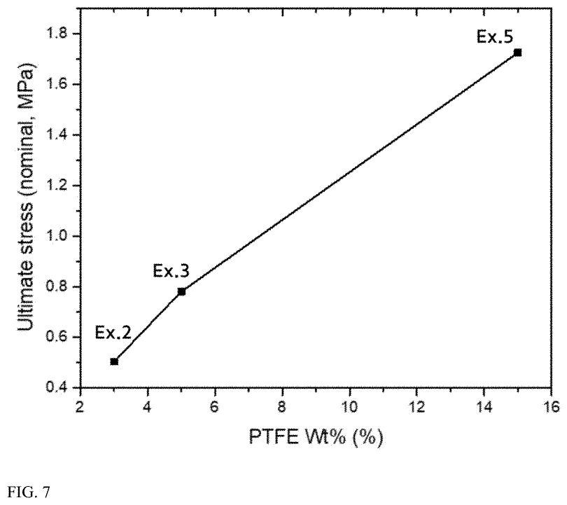

FIG. 6 shows the lithium ion conductivity of the solid electrolyte free-standing membrane according to Examples 1 to 5. These are summarized in Table 1 below.

TABLE 1

| Item | Example 1 | Example 2 | Example 3 | Example 4 | Example 5 |
|---|---|---|---|---|---|
| PTFE content | 1.5 | 3 | 5 | 10 | 15 |
| [% by weight] | | | | | |
| Li-ion | 3.95 | 2.51 | 2.67 | 0.26 | 0.15 |
| conductivity | | | | | |
| [mS/cm] | | | | | |

FIG. 6 shows the lithium ion conductivity of the sulfide-based solid electrolyte itself and the lithium ion conductivity of the Comparative Example.

The solid electrolyte free-standing membrane, according to an exemplary embodiment of the present disclosure, may have a lithium ion conductivity of 0.15 mS/cm or more.

Specifically, as the content of PTFE increases, the lithium ion conductivity tends to decrease, but the degree of decrease is very insignificant, and it can be seen that it is maintained almost without falling up to 5% by weight. Although the lithium ion conductivity of Example 5 was somewhat lowered, it showed a usable lithium ion conductivity of about 0.15 mS/cm, and since the mechanical properties to be described later are very excellent, it can be sufficiently used according to the purpose of the battery.

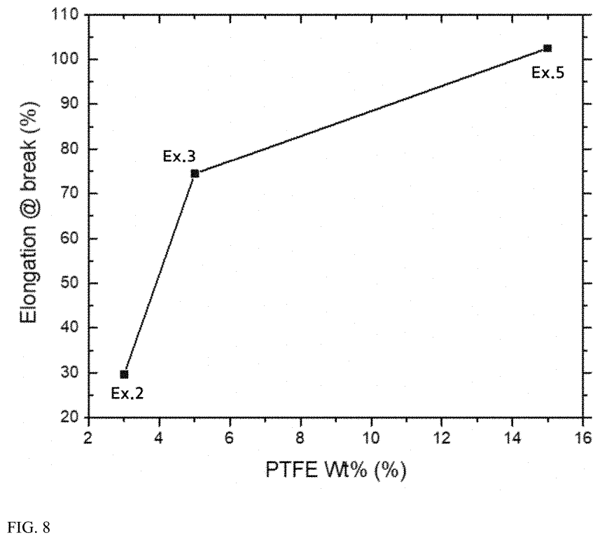

FIGS. 7 and 8 show the tensile strength and breaking elongation of the solid electrolyte free-standing membranes according to Examples 2, 3, and 5. These are summarized in Table 2 below.

TABLE 2

| Division | Tensile strength [MPa] | Elongation at the break [%] |
|---|---|---|
| Example 2 | 0.50 | 29.6 |
| Example 3 | 0.78 | 74.5 |
| Example 5 | 1.72 | 102.5 |

For reference, in the Comparative Example, the mechanical properties were too low, so the tensile strength and elongation at the break could not be measured.

According to an exemplary embodiment of the present disclosure, the solid electrolyte free-standing membrane may have a tensile strength of 0.5 MPa or more and an elongation at the break of 29.6% or more.

Specifically, it can be seen that the mechanical strength increases as the amount of PTFE increases. It can be seen that the flexibility is quite high due to the characteristics of PTFE.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A solid electrolyte free-standing membrane for an all-solid-state battery, the membrane comprising:
an amount of about 85% to 98.5% by weight of a sulfide-based solid electrolyte; and
an amount of about 1.5% to 15% by weight of a fibrillated polymer.

2. The solid electrolyte free-standing membrane of claim 1, wherein the fibrillated polymer has a diameter of about 0.01 μm to 10 μm.

3. The solid electrolyte free-standing membrane of claim 1, wherein the fibrillated polymer comprises polytetrafluoroethylene (PTFE).

4. The solid electrolyte free-standing membrane of claim 1,
wherein the solid electrolyte free-standing membrane is divided into area 1, area 2 and area 3 along a thickness direction from one surface with respect to a cross section thereof,
wherein thickness ratio of the area 1, area 2 and area 3 is 1:2.5:3.5, and
wherein when content of elemental sulfur in area 1 is represented as 100, content of elemental sulfur in each of area 2 and area 3 are in a range of about 80 to 120.

5. The solid electrolyte free-standing membrane of claim 1, wherein the solid electrolyte free-standing membrane has a thickness of about 100 μm to 200 μm.

6. The solid electrolyte free-standing membrane of claim 1, wherein a lithium ion conductivity of the solid electrolyte free-standing membrane is about 0.15 mS/cm or more.

7. The solid electrolyte free-standing membrane of claim 1, wherein a tensile strength of the solid electrolyte free-standing membrane is about 0.5 MPa or more, and breaking elongation of the solid electrolyte free-standing membrane is about 29.6% or more.

8. A method of manufacturing a solid electrolyte free-standing membrane for an all-solid-state battery, the method comprising:
preparing a mixture comprising a sulfide-based solid electrolyte and a polymer powder capable of fibrillating;
applying shear stress to the mixture so that the mixture becomes clay; and
forming the clay into a film to obtain the solid electrolyte free-standing membrane,
wherein the solid electrolyte free-standing membrane comprises an amount of about 85% to 98.5% by weight of a sulfide-based solid electrolyte and an amount of about 1.5% to 15% by weight of a fibrillated polymer.

9. The method of claim 8, wherein the polymer powder capable of fibrillating has an average diameter (D50) of about 1 μm to 1,000 μm.

10. The method of claim 8, wherein the mixture does not contain a solvent.

11. The method of claim 8, wherein the shear stress is applied to the mixture so that the polymer powder to undergo fibrillation.

12. The method of claim 8, wherein the fibrillated polymer has a diameter of about 0.01 μm to 10 μm.

13. The method of claim 8, wherein the fibrillated polymer comprises polytetrafluoroethylene (PTFE).

14. The method of claim 8,
wherein the solid electrolyte free-standing membrane is divided into area 1, area 2 and area 3 along a thickness direction from one surface with respect to a cross section thereof,
wherein thickness ratio of the area 1, area 2 and area 3 is 1:2.5:3.5, and
wherein when content of elemental sulfur in area 1 is represented as 100, content of elemental sulfur in each of area 2 and area 3 are in a range of about 80 to 120.

15. The method of claim 8, wherein the solid electrolyte free-standing membrane has a thickness of about 100 μm to 200 μm.

16. The method of claim 8, wherein a lithium ion conductivity of the solid electrolyte free-standing membrane is about 0.15 mS/cm or more.

17. The method of claim 8, wherein a tensile strength of the solid electrolyte free-standing membrane is about 0.5 MPa or more, and breaking elongation of the solid electrolyte free-standing membrane is about 29.6% or more.
